(19) United States
(12) Patent Application Publication
(10) Pub. No.: US 2009/0005124 A1
(43) Pub. Date: Jan. 1, 2009

(54) METHODS AND DEVICES FOR MESSAGE ALERT MANAGEMENT

(75) Inventor: CLARK D. ELMORE, HOFFMAN ESTATES, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/770,901

(22) Filed: Jun. 29, 2007

(51) Int. Cl. H04B 1/38; H04M 3/00

(52) U.S. Cl. 455/567; 455/414.1; 455/418; 455/566

(57) ABSTRACT

Disclosed are methods and mobile communication devices for discontinuing or muting an incoming call alert for a predetermined period of time by pressing a ringer control key. After the predetermined period of time ends, the device may resume its previous incoming call alert setting. Accordingly, by pressing a ringer control key which is typically on one side of the housing, a user may place the incoming call alert, for example, in a silent mode. If placed in silent mode, a user may need not to remember to depress the ringer control key again to change the incoming call alert back to, for example, its previous incoming call alert setting since it may automatically revert back to its previous setting. Therefore, a user may not unintentionally miss incoming calls.

### FIELD

Disclosed are methods and devices for discontinuing or muting an incoming call or message alert, and more particularly, discontinuing or muting an incoming call or message alert for a predetermined period of time by pressing a ringer control key.

### BACKGROUND

Mobile communication devices have become very common in today's world. In certain situations incoming call alerts for a mobile communication device, such as ringing or other audible sounds, can be intrusive. For example, in meetings, at public performances or entertainment events, or in a quiet restaurant, a ringing mobile communication device may be considered intrusive. During a face-to-face conversation, a ringing mobile communication device may be an unwanted distraction. In other situations, there are rules against ringing mobile communication devices. For example, in classrooms and courtrooms ringing cellular telephones may be banned. Additionally, a cellular telephone user may simply wish to be undisturbed by a cellular telephone ring at a particular time.

A user may place a cellular telephone on a silent incoming call alert, such as a vibrator. In certain situations, such a solution may be practical. However, oftentimes if the alert is silent, a user may forget that the incoming call indicator was placed on a silent mode, and miss otherwise desired incoming calls since the audible alert was off. A ringer control key, typically on one side of the housing, can place the incoming call alert in a silent mode by a user depressing the key. If placed in silent mode, a user must remember to depress the key again to change the ringer control back to an audible alert mode so that the user may be audibly alerted to incoming calls.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts an electronic device 102 that may be for example, a mobile communication device;

FIG. 2 is an embodiment of a method of the above-described mobile communication device; and

FIG. 3 is a method diagram depicting different embodiments of displaying a query or a menu to effect a preset timed discontinuation of an incoming call alert upon the mobile communication device by detecting press of a ringer control key.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Disclosed are methods and mobile communication devices for discontinuing or muting an incoming call alert for a predetermined period of time by pressing a ringer control key. After the predetermined period of time ends, the device may resume its previous incoming call alert setting. Accordingly, by pressing a ringer control key which is typically on one side of the housing, a user may place the incoming call alert, for example, in a silent mode. If placed in silent mode, a user may need not to remember to depress the ringer control key again to change the incoming call alert back to, for example, its previous incoming call alert setting since it may automatically revert back to its previous setting. Therefore, a user may not unintentionally miss incoming calls.

In one embodiment, when a user presses the ringer control button, a query or menu may appear on the display of the mobile communication device. The user may input a selected predetermined time for the discontinuation of the incoming call alert. The incoming call alert may therefore be discontinued for the predetermined period of time. In another embodiment, the predetermined period of time may be a preset period time. Therefore, when a user presses the ringer control button, the discontinuation of the incoming call alert may be activated for the preset predetermined period of time, not requiring any user input at that time. Again, a user may need not to remember to depress the ringer control key again to change the incoming call alert back to, for example, its previous incoming call alert setting since it may automatically revert back to its previous setting. Therefore, a user may not unintentionally miss incoming calls.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims. It is understood that the use of relational terms, if any, such as first and second, up and down, and the like are used solely to distinguish one from another entity or action without necessarily requiring or implying any actual such relationship or order between such entities or actions.

At least some inventive functionality and inventive principles may be implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

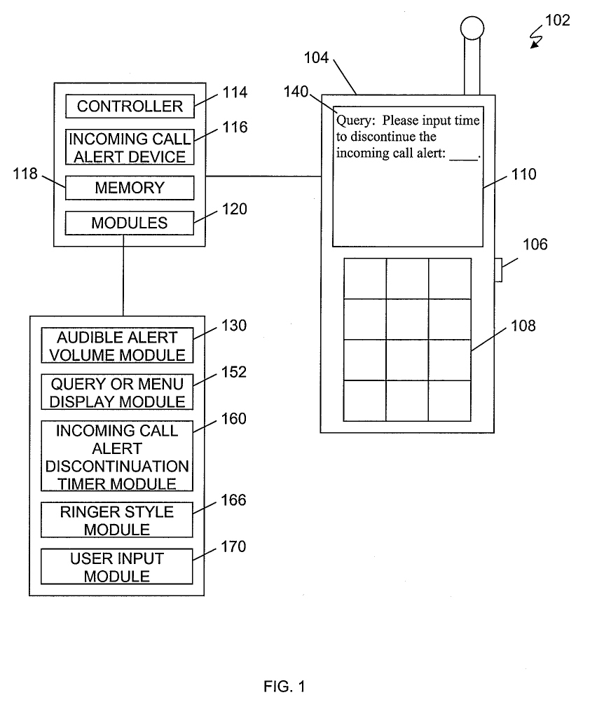

FIG. 1 depicts an electronic device 102 that may be for example, a mobile communication device. The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The mobile communication device may include a housing 104 a ringer function selection button 106 supported by the housing 104. While depicted on the side of the housing 104, a ringer control key can be in any position on the housing. For example, the ringer control key may be a soft key on the keypad 108. The display 110 may provide an indication of the ringer control key that is a soft key. It is understood that the ringer control key or incoming call alert control key may have any configuration and may be activated in any suitable manner.

A controller 114 may be disposed within the housing 104 and an incoming call alert device may be disposed within the housing 104 and coupled to the controller 114. The ringer control key, incoming call alert control key or ringer function selection button 106 may supported by the housing 104 and coupled to the controller 114. The controller 114 may be configured to access an incoming call alert discontinuation timer control that may be in hardware or software in response to a press of the ringer function selection button 106.

A memory 118 and modules 120 may also be supported by the housing 104. The modules 120 may include, for example, an audible alert volume module 130, a query or menu display module 152, an incoming call alert discontinuation timer module 160, a ringer style module 166, and a user input module 170. The modules can carry out certain processes of the methods as described herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules 120 will be discussed in more detail below.

A user may depress the ringer control key 106 so that controller 114 may receive a timed discontinuation control signal for discontinuing the incoming call alert of the mobile communication device 102 for a predetermined time in response to a selected time option. The selected time option may be input to the mobile communication device in any number of manners. For example, when the user presses the ringer control key 106 of the mobile communication device 102, a selection query may be displayed on the display 110 of the mobile communication device in response to a detected press of the ringer control key 106. In one embodiment, a selection query 140 may indicate, for example, “Query: Please input time to discontinue the incoming call alert: ______.” A user may then use the keypad 108, or any other method such voice recognition software, to enter in a time to discontinue the incoming call alert. In this way, the user has provided at least one time option for generating a timed discontinuation control signal for discontinuing the incoming call alert.

The display screen or verbal requests made by, for example a speech synthesizer, may be utilized by the mobile communication device 102 to allow the user to set the predetermined time for discontinuation of an incoming call alert. In one embodiment, a menu may be displayed on the display screen 110. The user may be given an option as to how much time the user may wish to discontinue activation of the incoming call alert. For example, a predetermined time option may be selected from the group consisting of 2.5 hours, 4 hours, 8 hours, and 12 hours. In another embodiment, predetermined time options may be, for example, in increments of 5, 10, 15 or 30 minutes. Increments may be any length of time, or may be randomly selected. The increments as discussed in this disclosure may be referred to as stepped time increments. Such time options may be set by user preferences or may be provided by the manufacturer during manufacture, or may be downloaded. It is understood, that the predetermined time period for the discontinuation of the incoming call alert, and then its subsequent reactivation, may be input to the device in any manner. For example, were a user to wish to discontinue the message or call alert during a movie or some other common event such as a radio show, TV show which may be preset by a user or may be indicated by default, a prompt or menu may include the term “movie” instead or in addition to a time option. Moreover, an incoming call alert may be an audible alert, such as a ring or song, or may be a silent alert, such as a vibration.

The user may have a certain period of time for which he or she prefers to discontinue the incoming call alert of the mobile communication device 102. For example, a user may frequently need the incoming call alert discontinued for 15 minutes at a time. Therefore, the user may preset the timed discontinuation control for 15 minutes. In such an embodiment, the query provided to the user may also ask whether to make the preset timed discontinuation control the default setting.

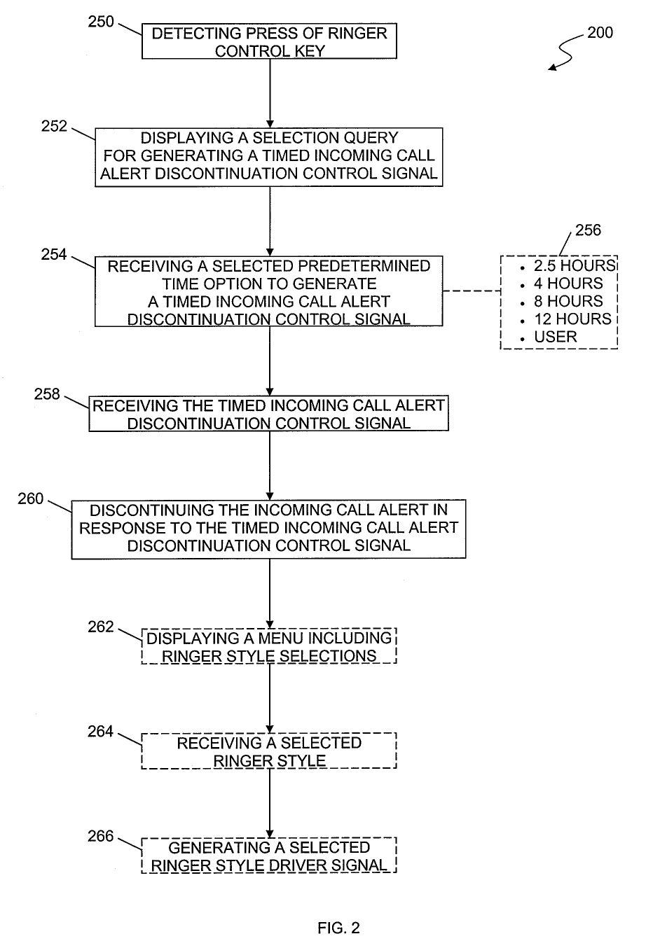

FIG. 2 is an embodiment of a method of the above-described mobile communication device. Steps of a method 200 of a mobile communication device that may be configured to generate an incoming call alert in accordance with the incoming call alert device 116 (see FIG. 1) may include, for example, detecting a press of a ringer control key of the mobile communication device 250. As mentioned above, the method may include displaying on a display of the mobile communication device in response to a detected press of the ringer control key a selection query 252 including at least one time option for generating a timed discontinuation control signal for discontinuing the incoming call alert. Displaying the query may be in accordance with the query display module 152. The method may further include receiving a selected predetermined time option to generate a timed incoming call alert discontinuation control signal 254. As mentioned above, the query may be in the form of a single query, or in the form of a menu 256. The controller 114 may accordingly receive the timed discontinuation control signal for discontinuing the incoming call alert of the mobile communication device for a predetermined time in response to a selected time option 258. Accordingly, the incoming call alert may be discontinued for a predetermined period of time 260 in response to the timed discontinuation control signal in accordance with the incoming call alert discontinuation module 160. As mentioned above, after the predetermined period of time is over, the mobile communication device may resume its previous incoming call alert setting. In the alternative, in another embodiment, if a user has changed the call alert setting, the device may resume an audible incoming call alert that is different from its previous setting.

The disclosed method may further include displaying on a display of the mobile communication device in response to a detected press of the ringer control key a query or a menu that may be displayed on a display 110 (see FIG. 1) of the mobile communication device 102 in response to a detected press of the ringer control key 106 including audible alert style selections 262 for driving a style of an audible alert response. The controller 114 may receive a selected audible alert style 264 and may generate a selected audible alert style driver signal in response to the selected audible alert style response 266 in accordance with ringer style module 166. A selection of an audible alert style may be made at any time. For example, a selection of an audible alert style may be made before selection of a timed discontinuation of an incoming call alert or after selection of a timed discontinuation of an incoming call alert. Moreover, a similar control may change the volume of an audible alert in accordance with the audible alert volume module 130.

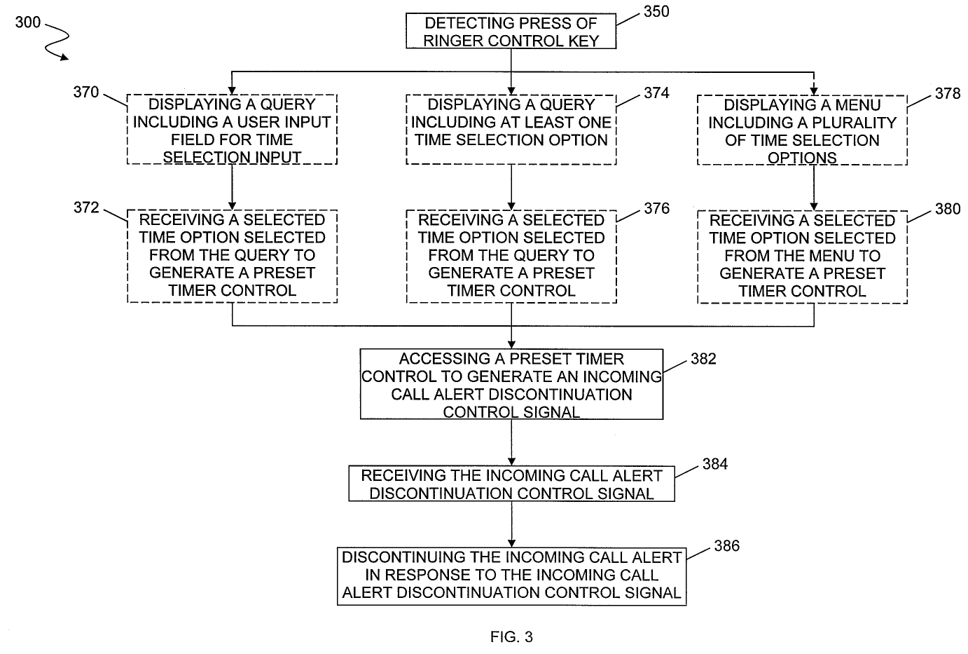

FIG. 3 is a method diagram 300 depicting different embodiments of displaying a query or a menu to effect a preset timed discontinuation of an incoming call alert upon the mobile communication device 102 (see FIG. 1) detecting press of a ringer control key 350. In one embodiment, a query may be displayed including a user input field for inputting a time selection 370 in accordance with user input module 170. That time selection may be received and stored 372. In another embodiment, a query may be displayed including at least one time selection option 374 in accordance with query or menu display module 152. That time option selection may be received and stored 376. In still another embodiment, a menu may be displayed including a plurality of time selection options 378 in accordance with the query or menu display module 152. That time option selection may be received and stored 380. Setting up the preset timer control may be performed sequentially with a first press of the ringer control key or may be stored for a later utilization.

A detection of a press by the ringer control key 350 may activate the preset timer control. The method may include accessing a present timer control to generate a preset timed discontinuation of an incoming call alert 382 on the mobile communication device 102 (see FIG. 1). The controller may receive the timed discontinuation of an incoming call alert 384 and may discontinue the incoming call alert in response to the received timed discontinuation of an incoming call alert 386. A similar preset control may change the volume of an audible alert in accordance with the audible alert volume module 130.

The disclosed methods and mobile communication devices for discontinuing or muting an incoming call alert for a predetermined period of time by pressing a ringer control key may allow a user to not unintentionally miss incoming calls. In one embodiment, when a user presses the ringer control button, a query or menu may appear on the display of the mobile communication device. The user may input a selected predetermined time for the discontinuation of the incoming call alert. The incoming call alert may therefore be discontinued for the predetermined period of time. In another embodiment, the predetermined period of time may be a preset period time. Therefore, when a user presses the ringer control button, the discontinuation of the incoming call alert may be activated for the preset predetermined period of time, not requiring any user input at that time. In an alternative embodiment, the volume of an audible incoming call alert may be changed for a predetermined period of time. After the predetermined period of time ends, the device may resume its previous incoming call alert setting or assume another. Again, a user may need not to remember to depress the ringer control key again to change the incoming call alert back to, for example, its previous incoming call alert setting since it may automatically revert back to its previous setting. Therefore, a user may not unintentionally miss incoming calls.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A method of a mobile communication device configured to generate an incoming call alert, the method comprising:
detecting a press of a ringer control key of the mobile communication device;
displaying on a display of the mobile communication device in response to a detected press of the ringer control key a selection query including at least one time option for generating a timed discontinuation control signal for discontinuing the incoming call alert;
receiving the timed discontinuation control signal for discontinuing the incoming call alert of the mobile communication device for a predetermined time in response to a selected time option; and
discontinuing the incoming call alert in response to the timed discontinuation control signal.

2. The method of claim 1, wherein generating an incoming call alert comprises:
generating at least one of an audible incoming call alert or a silent incoming call alert.

3. The method of claim 1, wherein the selection query includes at least one predetermined time option, the method further comprising:
receiving a selected predetermined time option selected from the selection query to generate timed discontinuation control signal of the incoming call alert.

4. The method of claim 1, wherein the query is a menu that includes a plurality of predetermined time options, the method further comprising:
receiving as the selected time option selected one of the plurality of predetermined time options from the menu to generate timed discontinuation control signal of the incoming call alert.

5. The method of claim 3, wherein a predetermined time option is selected from the group consisting of stepped time increments.

6. The method of claim 1, wherein the selection query provides an option for user input to determine a time option, the method further comprising:
receiving a user generated time option to generate the timed discontinuation control signal of the incoming call alert.

7. The method of claim 1, further comprising;
displaying on a display of the mobile communication device in response to a detected press of the ringer control key a menu including audible alert style selections for driving a style of the audible alert response;
receiving a selected audible alert style; and
generating a selected audible alert style driver signal in response to the selected audible alert style response.

8. A method of a mobile communication device configured to generate an incoming call alert, the method comprising:
detecting a press of a ringer control key of the mobile communication device;
accessing a preset timer control to generate a timed discontinuation control signal for discontinuing the incoming call alert for a predetermined period of time in response to the detected press of the ringer control key;
receiving the timed discontinuation control signal for discontinuing the incoming call alert of the mobile communication device for the predetermined time; and
discontinuing the incoming call alert in response to the timed discontinuation control signal.

9. The method of claim 8, wherein generating an incoming call alert comprises:
generating at least one of an audible incoming call alert or a silent alert.

10. The method claim 8, method further comprising:
displaying on a display of the mobile communication device in response to a detected press of the ringer control key a query including at least one time selection option; and
receiving a selected time option selected from the query to generate the preset timer control to discontinue the incoming call alert.

11. The method claim 8, method further comprising:
displaying on a display of the mobile communication device in response to a detected press of the ringer control key a menu including a plurality of time selection options; and
receiving a selected time option selected from the menu to generate the preset timer control to discontinue the incoming call alert.

12. The method of claim 11, wherein the plurality of time selection options includes the group consisting of stepped time increments.

13. The method claim 8, method further comprising:
displaying on a display of the mobile communication device in response to a detected press of the ringer control key a query for user input to determine a time option; and
receiving a determined time option from the user input to generate the preset timer control to discontinue the incoming call alert.

14. A mobile communication device, comprising:
a housing;
a controller disposed within the housing;
a incoming call alert device disposed within the housing and coupled to the controller; and
a ringer function selection button supported by the housing and coupled to the controller;
wherein the controller is configured to access an incoming call alert discontinuation timer control in response to a press of the ringer function selection button.

15. The device of claim 14, further comprising:
a display that in response to a detected press of the ringer control key is configured to display a query including at least one time selection option for the incoming call alert discontinuation timer control.

16. The device of claim 15, wherein the query is a menu that includes a plurality of predetermined time selection options for the incoming call alert discontinuation timer control.

17. The device of claim 16, wherein the predetermined time selection option includes the group consisting of stepped time increments.

18. The device of claim 14 wherein the query provides an option for user input to generate a time selection for the incoming call alert discontinuation timer control.
